(19) United States
(12) Patent Application Publication
(10) Pub. No.: US 2003/0219605 A1
(43) Pub. Date: Nov. 27, 2003

(54) Novel friction and wear-resistant coatings for tools, dies and microelectromechanical systems

(75) Inventors: Palaniappa A. Molian, Ames, IA (US); Melissa Womack, Ames, IA (US)

Correspondence Address: MCKEE, VOORHEES & SEASE, P.L.C., 801 GRAND AVENUE, SUITE 3200, DES MOINES, IA, 50309-2721, US

(73) Assignee: Iowa State University Research Foundation Inc., Ames, IA

(21) Appl. No.: 10/354,722

(22) Filed: Jan. 30, 2003

Related U.S. Application Data
(60) Provisional application No. 60/367,338, filed on Feb. 14, 2002.

(51) Int. Cl. B32B 27/00

(52) U.S. Cl. 428/422; 106/637

(57) ABSTRACT

New, layered, wear-resistant composites comprising a material having a hardness exceeding 30 GPa, preferably AlMgB₁₄ and a fluorinated polymer, preferably poly(tetrafluoroethylene), and tools and microelectromechanical devices coated with the same, are disclosed. A process to prepare the wear-resistant materials is also disclosed.

### GRANT REFERENCE

This research was federally funded under NSF Award Number DMI-0084969. The Government may have certain rights in the invention.

### FIELD OF THE INVENTION

This invention relates to new wear-resistant materials and workplace tools and microelectromechanical devices coated with the same. The invention also relates to a process to prepare the wear-resistant materials.

### BACKGROUND OF THE INVENTION

A cutting tool must be hard, tough and chemically inert, even at elevated temperatures, and must have a low coefficient of friction against the material to be machined, and finally, should have a low thermal conductivity. More than 40% of all cutting tools are coated with wear-resistant coatings.

A recent development at the nanoscale engineering level involves the production of fibers, films, and particles having a size on the order of nanometers. These nanomaterials have unique properties in terms of strength, ductility, hardness, toughness, wear resistance, and corrosion resistance, which are often superior to the traditional materials. The techniques for synthesis of nanomaterials include gas-phase condensation, electrodeposition, mechanical alloying, laser ablation, and sol-gel synthesis. The atomic level fabrication of these techniques leads to uniformity, purity, and homogeneity such that the mechanical and physical properties are precisely controlled. Nanocrystalline carbides are used as cutting tool inserts.

Recent advances in the tool and die industry have shown that the application of thin coatings (2-5 μm) on tool edges can substantially enhance the performance and life of tools. Hard coatings of the type TiN, TiC, (Ti,Al)N, Ti(C,N), Al₂O₃, CVD-diamond and cubic boron nitride (cBN) are used in a variety of tool and die applications, where these offer thermal stability and higher resistance to abrasive wear. However these coatings are usually microcrystalline, substantially thicker than nanocomposites and sometimes exhibit poor adhesion.

New developments in tool coatings include superlattices, multielement coatings and nanocomposites. Superlattice coatings consist of alternate layers of two hard materials, such as TiN/NbN, with nanoscale thickness. Unlike multilayer superlattice coatings, the multielement coating consists of eight different elements combined into one super thin coating. Both these developments offer greater tool life improvements (five to seven times) than traditional Ti-based coatings.

Nanocomposites are emerging material systems that contain nanocrystalline or nanocrystalline/amorphous structures. Examples include nc-TiN/a-Si₃N₄, nc-TiN/BN, nc-(TiAlSi)N and nc-TiN/TiB₂ (nc=nanocrystalline, a=amorphous). More recently, nc-TiN/a-Si₃N₄ composite thin films with a hardness of 105 GPa have been prepared, exceeding the hardness of diamond. However, the performance of superhard coatings in machining is varied. Superhard TiB₂/TiN displayed a shorter lifetime than TiN and higher flank wear. In contrast, nc-(TiAlSi)N films showed the smallest flank wear compared with TiN and TiAlN coatings. S. Veprek, J. Vac. Sci. Technol. A 17, 2401 (1999). A drawback of these nanocomposites is that they are not self-lubricating when used in cutting applications.

Pulsed Laser Deposition (PLD) is a conceptually and experimentally simple yet highly versatile technique for thin film applications. In PLD, a target inside a vacuum chamber is irradiated by an intense source of laser radiation, creating a plasma plume. The plasma, containing nanoparticulates, is then deposited onto and adheres to the material to be coated (substrate). Among several physical vapor deposition techniques, PLD is perceived as a superior method to deposit nanocomposite thin films because of PLD's ability to faithfully reproduce complex stoichiometry and crystal structures. Another unique feature of PLD is the generation of high-energy, high-velocity particles (ionized and excited species) from the coupling of a large optical field with the solid target, promoting film crystallinity and dense packing. PLD has experienced explosive growth in the past decade, especially since its successful use with superconducting oxides. It has been employed in the preparation of high quality dielectric films, epitaxial semiconductor layers, superlattices and ceramics, nanocrystalline materials, ferroelectrics, amorphous diamond, tribological coatings and polymers.

Excimer lasers are mostly used for Pulsed Laser Deposition because of their short wavelengths (193-351 nm), high energy per pulse (0.1 to 5 J), and nanosecond (10-30 ns) pulse widths. Q-switched Nd:YAG lasers in the frequency-tripled or quadrupled modes with pulse duration of 4-12 ns may also be used. However, these nanosecond-pulsed lasers have some serious drawbacks that have minimized their industrial success including (1) low deposition rates (less than 1 μm/hour) due in part to low repetition rates (1-10 Hz), (2) difficulty in ablating high heat conductivity materials such as metals and semiconductors because heat is distributed over a distance of some microns during the pulse duration, and (3) handling problems due to the presence of corrosive gases in the excimer laser.

In contrast, with femtosecond pulsed lasers, the photons can be tightly packed to form an extremely short pulse, emitting very high intensities (up to 10²¹ W/cm²) and short pulse widths (as small as 10⁻¹⁵ sec). The commercially successful Ti:Sapphire (800 nm) lasers exhibit pulse energies up to 5 mJ with pulse widths of 20-200 fs and repetition rates of up to 5 kHz. The Ti:Sapphire system is also tunable within a range of near-infrared wavelengths 735 nm-1053 nm. The beam quality of Ti:Sapphire (about 95% Gaussian) is superior to that of excimer and YAG lasers. High spatial resolution and clean ablation are achievable with femtosecond pulsed lasers because of reduced thermal effects and the absence of plasma above the surface.

An emerging concept in coatings is to mix alternating hard and soft layers to improve toughness, chemical resistance and lubrication. J. Wang, et al., Thin Solid Films 342, 291 (1999). Cracks initiated in hard, brittle layers are arrested when they meet the soft, tough layer. The layered composite disclosed by Wang, et al., is formed by sputtering. Sputtered films, such as MoS₂, have poor thermal stability and higher coefficients of friction than the corresponding bulk materials. Nishimura, et al., Proc. of Symposium on Tribochemistry, Lanzhou, China, 213 (1989). Films formed by PLD do not have these shortcomings. Hard/soft composites are also known with MoS₂ as the soft, lubricious layer. However, these composites are only good for vacuum environments because MoS₂ oxidizes very slowly in air and the lubricating properties of MoS₂ degrade in air with the absorption of water.

The family of fluoropolymers offers plastics with high chemical resistance, low and high temperature capability, low friction and electrical and thermal insulation. Polytetrafluoroethylene (PTFE) is a well-known soft, chemically inert, electrically insulating, thermoplastic fluoropolymer with a low coefficient of friction (0.05 to 0.2). Fluorinated ethylene propylene copolymer (FEP) is a copolymer of polytetrafluoroethene and hexafluoropropylene. It is a soft plastic with high chemical resistance, a low coefficient of friction and is useful over a wide temperature range. Perfluoroalkoxy polymer (PFA) is a fully fluorinated polymer with oxygen cross-links between chains. PFA has similar characteristics to PTFE and FEP.

Hard materials other than the nanocomposites mentioned above include diamond, carbides, nitrides and borides including AlMgB₁₄ and AlMgB₁₄:X wherein X is present in an amount from 5 weight percent to 30 weight percent and comprises a doping agent selected from the group consisting of Group III, IV and V elements and borides and nitrides thereof, said ceramic having a hardness greater than AlMgB₁₄. Examples of X include silicon, phosphorous, carbon, TiB₂, AlN and BN. B. A. Cook, et al., U.S. Pat. No. 6,099,605, which is incorporated by reference. AlMgB₁₄ is unexpectedly hard. Its low symmetry crystal structure, large number of atoms per unit cell and, in some specimens, incompletely occupied atom sites contradict the accepted precepts for extreme hardness. An additional paradox is that some additives increase the hardness of the material. B. A. Cook, et al., Scripta mater. 42, 597 (2000). The lower raw material costs of AlMgB₁₄ combined with its high hardness makes it an attractive alternative to diamond for industrial cutting tools.

Hardness is a fundamental parameter that measures the resistance of a material to an applied compressive load. Examples of selected hard materials are listed in Table 1. A unit for hardness is the gigapascal (GPa). A GPa is equal to 10⁹ pascals. Each pascal is equal to a newton per square meter.

TABLE 1
Selected Hard Materials

| Hard material | hardness (GPa) |
|---|---|
| C (diamond) | 70-90 |
| Cubic BN | 50-60 |
| SiC | 24-28 |
| A1₂O₃ | 21-22 |
| TiB₂ | 30-33 |
| WC | 23-30 |
| TiC | 28-29 |
| Si₃N₄ | 17-21 |
| AlB₁₂ | 26 |
| AlMgB₁₄ | 35-40 |

Microelectromechanical systems (MEMS) is a manufacturing technology; a way to make electromechanical systems using batch fabrication techniques similar to the way integrated circuits are made. Microelectromechanical components are fabricated with micromachining processes that selectively etch away parts of a silicon wafer to add new structural layers. MEMS technology allows the integration of microelectronics with active perception and control functions. Examples of microelectromechanical devices include sensors, actuators, valves, gear trains, turbines, nozzles, membranes and pumps with dimensions from a few to a few hundred microns. Fundamental problems with microelectromechanical components include stiction, the static adhesion of parts to one another, and wear from friction. There is a need for a coating on microelectromechanical components that is hard, has a low coefficient of friction and is ultrathin, so as not to greatly change the dimensions of the components.

In summary, while hard materials have been known in the past, and nanomaterial deposition techniques have been known in the past, and finally, while multielement coatings have been known, no one has been able to develop a super-hard (>30 GPa), lubricious material that can be effectively deposited by pulsed laser deposition to provide an effective wear-resistant coated workpiece tool.

The combination of super-hard/fluoropolymer materials in the form of layered composites is novel. Existing composites, including commercial coatings applied to workplace tools, lack durability in part due to a lack of hardness and/or lubricity. In addition, composites containing AlMgB₁₄ are novel due to the recent development of AlMgB₁₄. Femtosecond pulsed laser deposition is for the first time applied to make the super-hard/fluoropolymer composites. The combination of femtosecond pulsed laser deposition and hard/lubricious coatings may now, for the first time, be applied to make more durable microelectromechanical devices, tools and dies.

The primary objective of this invention is to fulfill the above described needs with a new wear-resistant composite, and to provide a method for making the wear-resistant composite.

It is another object of the present invention to provide wear-resistant coatings for tools and dies.

It is another object of the present invention to provide wear-resistant coatings for microelectromechanical systems.

These and other objects, features and/or advantages of the present invention will become apparent from the specification and claims.

### BRIEF SUMMARY OF THE INVENTION

The present invention is wear-resistant, layered, composites comprising: a first material having a hardness exceeding 30 GPa and a second material which is a fluorinated polymer. A preferred first material is AlMgB₁₄. A preferred fluorinated polymer is PTFE. This combination provides a hard, tough and lubricious composite. The invention includes tools coated with the preferred wear-resistant composites. Such coated tools provide the advantage of increased wear-resistance, reduced cutting forces and lower temperatures at tool edges. Specifically, this invention will allow industry to extend high speed machining to further increase the productivity of expensive automated machines and transform many wet machining operations to dry machining, thereby eliminating environmentally hazardous cutting fluids. In addition, the invention includes microelectromechanical components and devices coated with the wear-resistant composites. Specifically, this invention will increase the lifetimes of microelectromechanical devices by reducing wear from friction. In addition, the invention includes a process to prepare the wear-resistant composites. The process provides the advantages of rapid deposition, uniform, smooth and continuous films with few particulates and strong adherence to tool edges. The technique of pulsed laser deposition is employed to make better coated tools.

### BRIEF DESCRIPTION OF THE DRAWINGS

FIG. 1 presents tool life test data in the form of nose wear for uncoated tools, tools coated with the composite of the invention, tools coated with AlMgB₁₄ and tools with a commercially available coating.

FIG. 2 presents tool life test data in the form of flank wear for uncoated tools, tools coated with the composite of the invention, tools coated with AlMgB₁₄ and tools with a commercially available coating.

FIG. 3 presents tool wear patterns of a tool coated with the composite of the invention (FIG. 3A) and a tool coated with a commercially available coating (FIG. 3B).

### DETAILED DESCRIPTION OF THE INVENTION

The invention, as hereinbefore explained, is a layered composite comprising a first material having a hardness exceeding 30 GPa and a fluorinated polymer. Preferred first materials are diamond, BN, TiB₂, AlMgB₁₄ and AlMgB₁₄:X, wherein X is present in an amount of from 5 weight percent to 30 weight percent and comprises a doping agent selected from the group consisting of Group III, IV and V elements and borides and nitrides thereof, and composites and nanocomposites thereof. Preferably, the first material has a hardness over 35 GPa. Preferred fluorinated polymers are PTFE and poly(ethylene-tetrafluoroethylene). Each layer of fluorinated polymer is preferably from 5 to 100 nm thick. Each layer of ultra-hard material is preferably from 5 to 300 nm thick.

The invention also relates to workplace tools, said tools having a layered, composite coating comprising a first material having a hardness exceeding 30 GPa and a fluorinated polymer. Preferred workplace tools are cutting tools and dies.

The invention also relates to microelectromechanical devices, said devices having a layered, composite coating comprising a first material having a hardness exceeding 30 GPa and a fluorinated polymer. Preferred microelectromechanical devices include sensors, actuators, valves, gear trains, turbines, nozzles, membranes and pumps.

The invention also relates to a process of preparing wear-resistant composites of a desired thickness. In a typical operation, a first material having a hardness exceeding 30 GPa is ablated with a laser beam and deposited onto a substate. Next, a fluorinated polymer is ablated with a laser beam and deposited onto the substrate. The two ablation and deposition steps are repeated until the desired thickness is reached. Preferably, the laser beam is emitted from a titanium sapphire laser. A preferred pulse width is 20 to 500 femtoseconds. A preferred pulse energy is 0.01 to 5 mJ. A preferred wavelength is from 735 to 1053 nm. A preferred substrate temperature is from ambient temperature to 550° C. A preferred deposition time is from 5 to 240 minutes. A preferred substrate is tungsten carbide.

The following example offers test results for the workplace tools of the present invention and is presented as illustrative and is not intended to be limiting in scope.

### EXAMPLE

Bulk PTFE sheets were purchased from GoodFellow Corporation. The sheets were cut into 1 in. by 1 in. squares, which were used as targets in the form of 12-mm diameter, 3-mm thick discs. The substrate selected for deposition was ISO designation CNMG 432-MR4-883 (obtained from Carboloy, Inc.). It is a superalloy-cutting grade that consists of WC-5% Co. The tool geometry is diamond polygon with an included angle of 80°, a relief angle of 0°, and a nose radius of 1/32 in. The surfaces of substrates were degreased in trichloroethylene and ultrasonically cleaned in methanol prior to deposition.

Pulsed laser deposition experiments were performed in a high-vacuum (10⁻⁶ torr) stainless steel chamber equipped with four vacuum ports and a quartz window that allowed observation of plasma. A 120-fs pulsed Ti:Sapphire laser was used to ablate the targets. The repetition rate was 1000 Hz. The laser beam was focused on the target at a 45° angle of incidence. During ablation, the target was rotated, which is needed to prevent cratering of the target by the laser beam and to minimize particulate formation. The spot size on the target was 0.002 mm². The substrate was oriented normal to the target, and the substrate-to-target distance was 76.2 mm.

The sequence of coating consisted of depositing a layer of AlMgB₁₄ followed by a layer of PTFE. AlMgB₁₄ deposition was performed for 30 minutes at pulse energy of 0.3 mJ (energy fluence of 15 J/cm²). The substrate temperature was maintained at 500° C. PTFE deposition was conducted for 10 minutes at higher pulse energy of 0.5 mJ (energy fluence of 25 J/cm²) and the substrate temperature was decreased to 400° C. The deposition process was facilitated by a computerized control system in which the laser parameters (power, pulses, and shutter), target rotation, target-to-substrate distance, and substrate temperature were controlled.

A Hitachi Seiki HT 20SII CNC turning center was used for conducting tool wear tests using coated and uncoated tungsten carbide inserts. Tool wear tests were also conducted using a commercially CVD-coated tool insert (Carboloy TP 200) for comparison purposes. The commercial coating consisted of three layers Ti(C,N)+Al₂O₃+TiN. The workpiece was 50-mm diameter heat-treated α-β Ti-6Al-4V titanium alloy bar stock. The cutting parameters are listed in Table 2. During machining tests, the nose and flank wears were measured using a Gaertner Scientific Toolmaker's Microscope at a magnification of 30×. Four to six readings were taken for each tool.

TABLE 2
Lathe Turning Parameters

| | |
|---|---|
| Feed Rate | 0.006 in./rev. |
| Surface Speed | 200 ft./min. |
| Depth of Cut | 0.03 in. |
| Cutting Length | 11 in. |
| Coolant/Lubricant | None |

Scanning electron microscopy analysis revealed the presence of uniform, smooth, and continuous films with occasional particulates. There was no evidence of porosity. Attempts to scratch the coating using the contact mode of the atomic force microscopy probe showed little to no particle formation for an estimated stress level of several MPa, implying strong adherence.

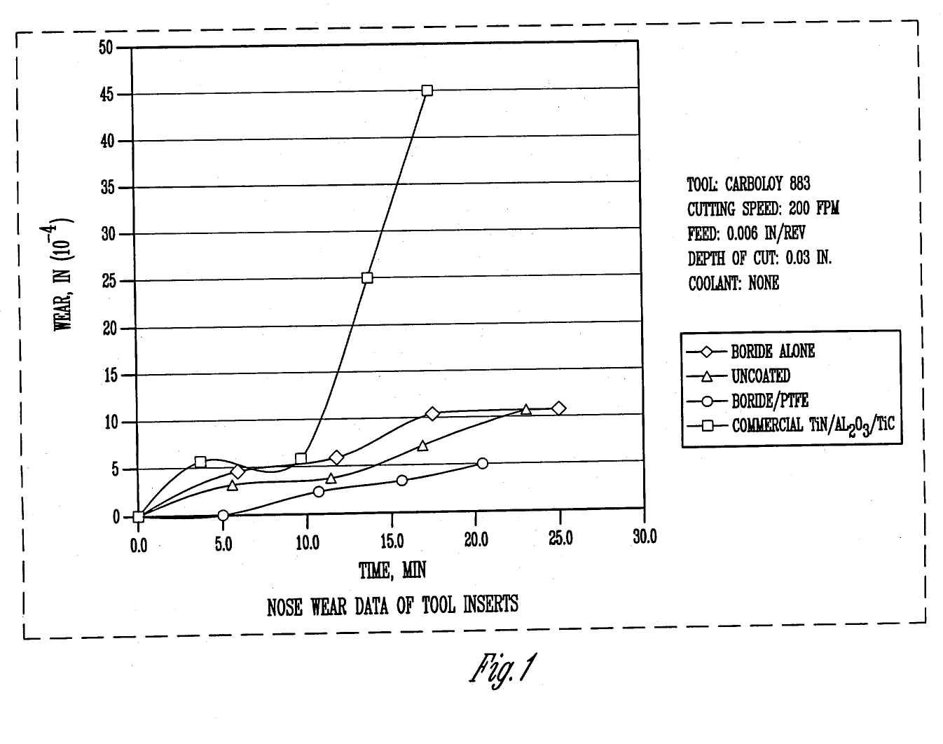

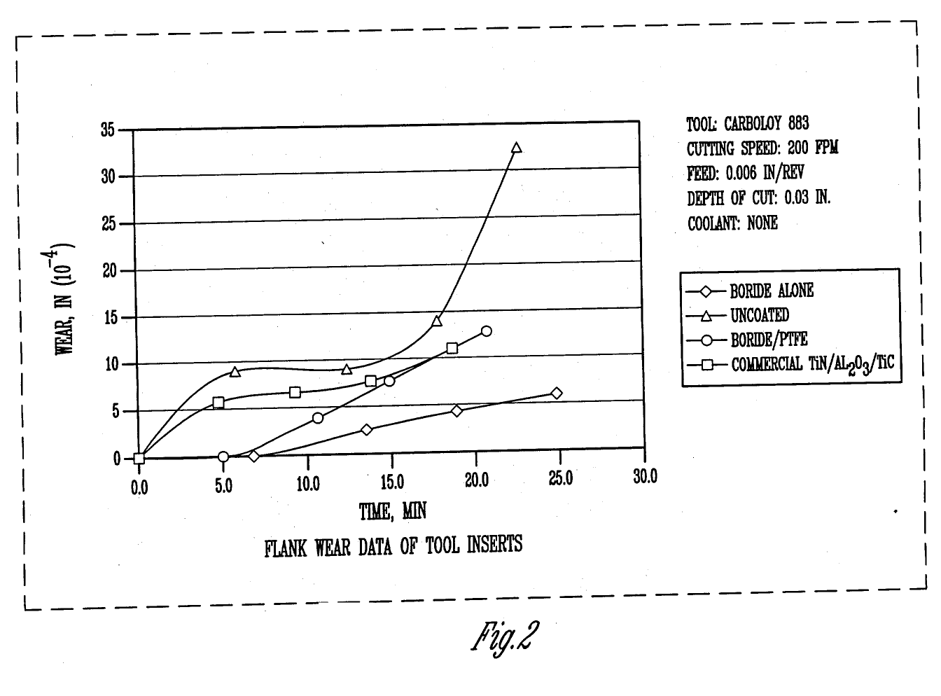

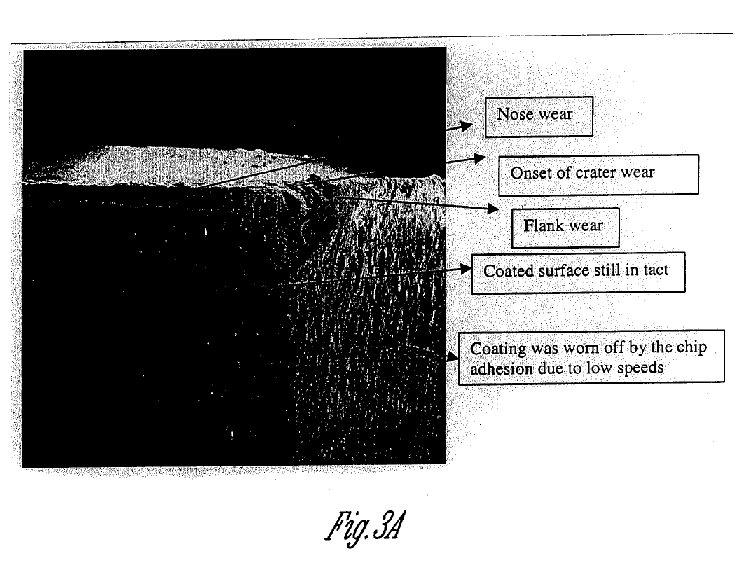

FIGS. 1 and 2 present the tool life test data in the form of flank and nose wear. Results are compared with commercially coated and uncoated tool inserts. The reductions in nose and flank wear were quite dramatic with the nanocomposite thin film coated tools especially when compared with the commercially coated tool. Nose wear-nanocomposite thin films were the most efficient among all tested and provided a wear reduction of nearly 90% over commercially coated and about 50% over uncoated tools. Flank wear-nanocomposite thin films provided a wear reduction over uncoated tools.

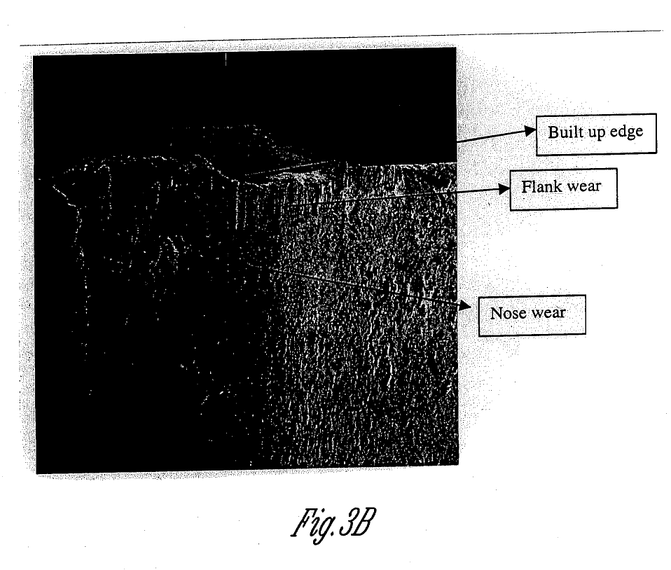

Scanning electron microscopy examination of wear patterns, shown in FIG. 3, revealed that the wear was much more rapid for the commercially coated tool (FIG. 3B) and involved material dissolution near the edge in the crater face and material deposition in the flank face. Consequently, the tool deteriorated rapidly for a run time of 18 minutes. However, for the tool coated with the composite of the invention (FIG. 3A), the coating prevented the diffusion of species from the tool to the workpiece reducing the crater wear and, by virtue of its abrasion resistance, eliminated the removal of particles from the tool, thereby reducing flank wear.

It can therefore be seen that the invention accomplishes all of its stated objectives and fulfills the need herein described.

It goes without saying that modifications can be made to the example and invention specifics described herein without departing from the spirit and scope of the invention.

What is claimed is:

1. A composite comprising:
a first layer of material having a hardness exceeding 30 GPa; and
a second layer of a fluorinated polymer.

2. The composite of claim 1 further comprising a plurality of first layers and a plurality of second layers.

3. The composite of claim 1 wherein the first layer of material has a hardness exceeding 35 GPa.

4. The composite of claim 1 wherein the first layer of material is selected from a group consisting of diamond, BN, TiB₂, AlMgB₁₄ and AlMgB₁₄:X, wherein X is present in an amount of from 5 weight percent to 30 weight percent and comprises a doping agent selected from the group consisting of Group III, IV and V elements and borides and nitrides thereof, and composites and nanocomposites thereof.

5. The composite of claim 4 where X is selected from a group consisting of silicon, phosphorous, carbon, TiB₂, AlN and BN.

6. The composite of claim 1 wherein the fluorinated polymer is selected from a group consisting of poly(tetrafluoroethylene), fluorinated ethylene propylene copolymer and perfluoroalkoxy polymer.

7. The composite of claim 1 which is formed into a wear-resistant coating material for a substrate.

8. The composite of claim 1 wherein the composite is a nanocomposite.

9. The composite of claim 1 wherein each layer of fluorinated polymer is from 5 to 100 nm thick.

10. The composite of claim 1 wherein each layer of the material with a hardness exceeding 30 GPa is from 5 to 300 nm thick.

11. A composite comprising a plurality of alternating layers of AlMgB₁₄ and poly(tetrafluoroethylene).

12. A workplace tool, said tool having a composite coating comprising:
a plurality of alternating layers of a material having a hardness exceeding 30 GPa; and
a plurality of layers of a fluorinated polymer.

13. The workplace tool of claim 12 wherein the material having a hardness exceeding 30 GPa is an orthorhombic boride of the general formula AlMgB₁₄ and the fluorinated polymer is poly(tetrafluoroethylene).

14. The workplace tool of claim 12 wherein the workplace tool is selected from a group consisting of cutting tools and dies.

15. A method of preparing wear-resistant coating materials of a desired thickness, comprising:
(a) ablating a material having a hardness exceeding 30 GPa with a laser beam,
(b) depositing the material having a hardness exceeding 30 GPa onto a substrate,
(c) ablating a fluorinated polymer with a laser beam,
(d) depositing the fluorinated polymer onto the substrate, and
(e) repeating steps (a) through (d) until the desired thickness is reached.

16. The method of claim 15 wherein the laser beam has a pulse width of 20 to 200 femtoseconds.

17. The method of claim 15 wherein the laser beam has a pulse energy of 0.01 to 5 mJ.

18. The method of claim 15 wherein the laser beam has a wavelength ranging from 735 to 1053 nm.

19. The method of claim 15 wherein the laser beam is emitted from a titanium sapphire laser.

20. The method of claim 15 wherein the substrate is maintained at a temperature from ambient temperature to 550° C.

21. The method of claim 15 wherein the deposition time is from 5 to 240 minutes.

22. The method of claim 15 wherein the substrate is tungsten carbide.

23. A microelectromechanical device, said device having a coating comprising:
a plurality of alternating layers of a material having a hardness exceeding 30 GPa; and
a plurality of second layers of a fluorinated polymer.

24. The microelectromechanical device of claim 23 wherein the microelectromechanical device is selected from a group consisting of sensors, actuators, valves, gear trains, turbines, nozzles, membranes and pumps.

25. The microelectromechanical device of claim 23 wherein the material with a hardness exceeding 30 GPa is an orthorhombic boride of the general formula AlMgB₁₄ and the fluorinated polymer is poly(tetrafluoroethylene).
